(19) United States
(12) Patent Application Publication
(10) Pub. No.: US 2011/0262125 A1
(43) Pub. Date: Oct. 27, 2011

(54) CAMERA

(75) Inventors: Ching-Chung Wang, Tao Yuan Shien (TW); Chuen-Hsiung Wang, Tao Yuan Shien (TW); Di-Lung Teng, Tao Yuan Shien (TW)

(73) Assignee: FACEVSION TECHNOLOGY INC., Tao Yuan Shien (TW)

(21) Appl. No.: 12/765,098

(22) Filed: Apr. 22, 2010

(51) Int. Cl. G03B 17/00

(52) U.S. Cl. 396/448

(57) ABSTRACT

A camera is provided. The camera includes a lens body, a first covering portion, a second covering portion and a rotating member. The first covering portion covers the lens body in a movable manner, and the second covering portion covers the lens body in a movable manner. The rotating member is rotatably disposed on the lens body and respectively connects the first covering portion and the second covering portion. The rotating member rotates to move the first covering portion and the second covering portion toward opposite directions.

### BACKGROUND OF THE INVENTION

1. Field of the Invention

The invention relates to a camera, and in particular, to a camera with double lens covers.

2. Description of the Related Art

A lens cover is utilized to protect the lens of a camera, preventing the lens from damage by debris or external impact. The conventional camera commonly comprises a single lens cover sliding on the camera body in order to open or close the camera lens. The lens cover is about the same width as the camera lens in order to completely cover the camera lens. In other words, an appropriate area on the camera body must be designed for the lens cover, such that the lens cover may slide on the camera body with no interference. As a result, the exterior design of the camera body is limited by the lens cover.

### BRIEF SUMMARY OF THE INVENTION

Accordingly, a camera is provided. The camera includes a lens body, a first covering portion, a second covering portion and a rotating member. The first covering portion covers the lens body in a movable manner, and the second covering portion covers the lens body in a movable manner. The rotating member is rotatably disposed on the lens body and respectively connects the first covering portion and the second covering portion. The rotating member rotates to move the first covering portion and the second covering portion toward the opposite directions.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A and 1B are schematic views of a camera of the invention showing a closed status and an opened status, respectively;

FIGS. 2A to 2C are schematic views of the camera of the invention showing the movement of a rotating member, a first covering portion and a second covering portion of the camera; and

FIG. 3 is a sectional view of the first covering portion and a second covering portion of the camera of the invention.

### DETAILED DESCRIPTION OF THE INVENTION

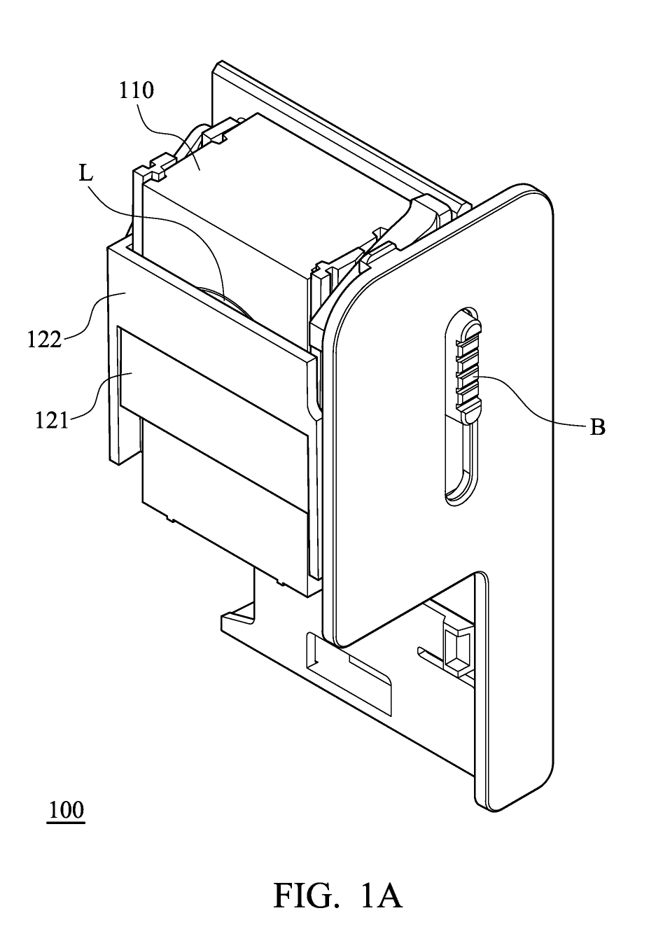

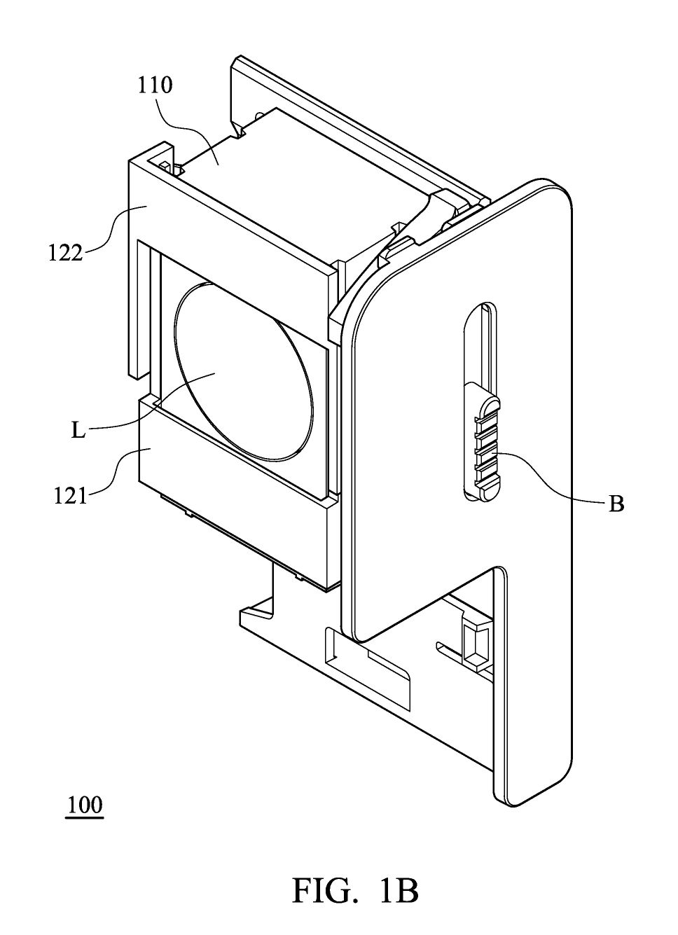

FIGS. 1A and 1B are schematic views of a camera of the invention showing a closed status and an opened status, respectively. Referring to FIGS. 1A and 1B, the camera 100 of the invention comprises a lens body 110, a first covering portion 121, a second covering portion 122 and a button B. The first covering portion 121 and the second covering portion 122, slide above the lens L on the lens body 121 by moving the button B, in order to close the lens L (as shown in FIG. 1A) or open the lens L (as shown in FIG. 1B).

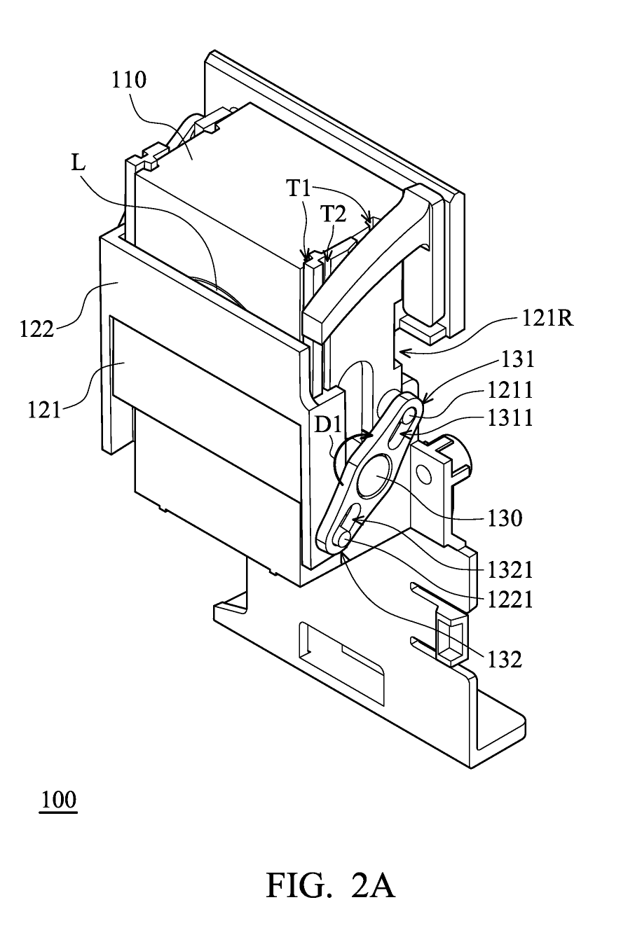

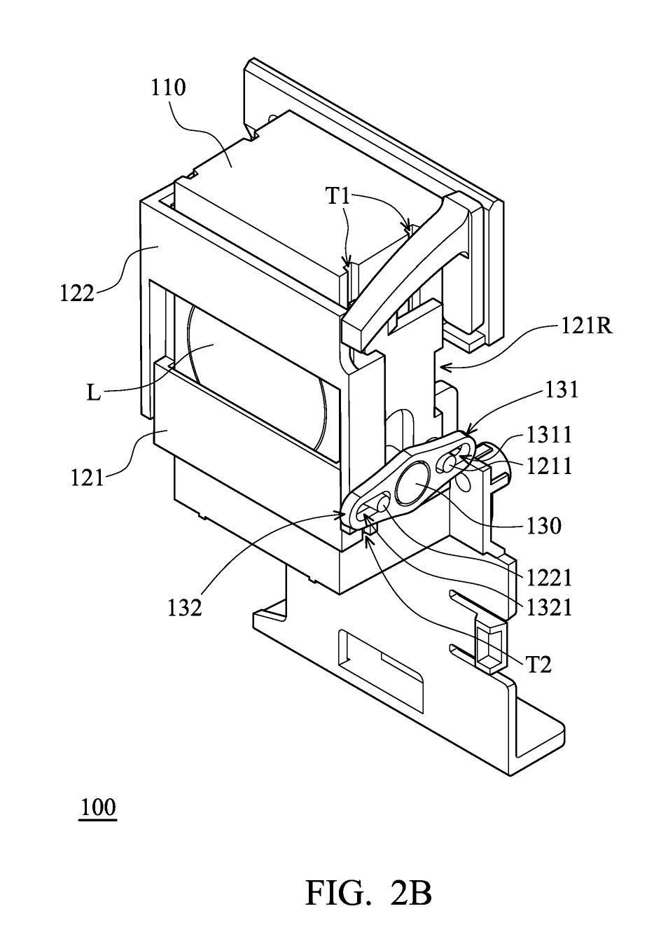

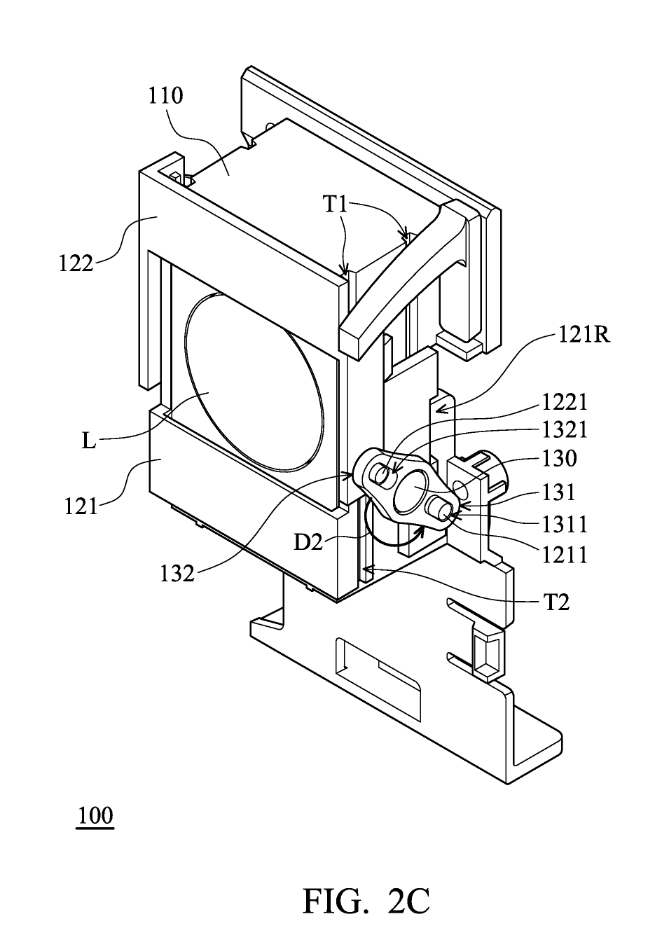

FIGS. 2A to 2C are schematic views of the camera of the invention showing the movement of a rotating member, a first covering portion and a second covering portion of the camera. Referring to FIGS. 2A to 2C, the camera 100 further comprises a rotating member 130 disposed on a side surface of the lens body 110. The rotating member 130 comprises a first end portion 131, a second end portion 132, a first opening 1311 and a second opening 1312. The first end portion 131 and the second end portion 132 are opposite to each other, and the first opening 1311 and the second opening 1312 are respectively formed on the first end portion 131 and the second end portion 132.

The lens body 110 comprises a first track T1, and the first covering portion 121 engages with the first track T1. The first covering portion 121 comprises a second track T2, and the second covering portion 122 engages with the second track T2. The first covering portion 121 comprises a first protrusion 1211, engaging with the first opening 1311, and the second covering portion 121 comprises a second protrusion 1221, engaging with the second opening 1321. When the rotating member 130 rotates, the first opening 1311 and the second opening 1321 would limit the movement of the first protrusion 1211 and the second protrusion 1221. Thus, while the rotating member 130 rotates, the first protrusion 1211 and the second protrusion 1221 are moved within the first opening 1311 and the second opening 1321 accordingly. In other words, the first covering portion 121 is moved in the first track T1 and the second covering portion 122 is moved in the second track T2 once the first protrusion 1211 and the second protrusion 1221 are pushed by the rotating member 130.

Referring to FIG. 2A, the first covering portion 121 and the second covering portion 122 cover the lens L. When the rotating member 130 moves in a first direction D1, the first end portion 131 and the second end portion 132 are twisted in the opposite directions. Thus, the first end portion 131 pushes the first protrusion 1211 in one direction and the second end portion 132 pushes the second protrusion 1221 in an opposite direction, such that the first covering portion 121 and the second covering portion 121 are moved in opposite directions to move away from each other (as shown in FIGS. 2B and 2C). Alternatively, referring to FIG. 2C, when the rotating member 130 moves in a second direction D2, the first end portion 131 and the second end portion 132 are also twisted in the opposite directions. Thus, the first end portion 131 pushes the first protrusion 1211 in one direction and the second end portion 132 pushes the second protrusion 1221 in an opposite direction, such that the first covering portion 121 and the second covering portion 121 are moved in opposite directions to move toward one another (as shown in FIG. 2A).

In another aspect, if the first covering portion 121 is moved to push the first end portion 131 of the rotating member 130, the other end (the second end portion 132) would be moved by the rotation of the rotating member 130. Thus, the second covering portion 122 is then moved simultaneously. Referring to FIGS. 1A and 2A, the first covering portion 121 has a notch 121R. The button B is disposed on an external housing and extended internally to engage with the notch 121R of the first covering portion 121. In this case, the user may push the button B to move the first covering portion 121 toward one direction, and then the second covering portion 122 would be correspondingly moved in an opposite direction. However, it should be noted that the operation of the closing and opening of the first and second covering portions 121, 122 is not limited above. For example, the closing and opening of the first and second covering portions 121, 122 can also be operated by direct rotation of the rotating member 130.

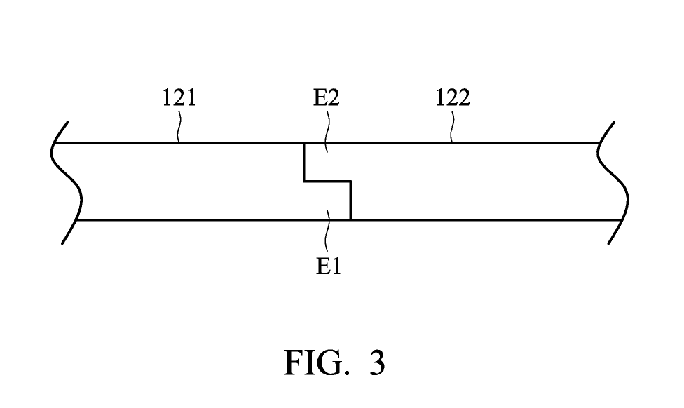

FIG. 3 is a sectional view of the first covering portion and a second covering portion of the camera of the invention. In a variant embodiment, referring to FIG. 3, the first covering portion 121 further comprises a first extending portion E1, and the second covering portion 122 further comprises a second extending portion E2. When the first covering portion 121 and the second covering portion 122 move toward each other till they abut each other, the first extending portion E1 overlaps the second extending portion E2 for further protection.

The camera of the invention utilizes two covering portions (121, 122) to cover the lens L. Because the two covering portions 121, 122 slide above the lens L, an area which is only half the width of the lens L is required for sliding. Thus, area is saved on both sides of the lens L to increase design flexibility and decrease size limitations.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A camera, comprising:
a lens body;
a first covering portion covering the lens body in a movable manner;
a second covering portion covering the lens body in a movable manner; and
a rotating member rotatably disposed on the lens body and respectively connecting the first covering portion and the second covering portion;
wherein the rotating member rotates to move the first covering portion and the second covering portion toward opposite directions.

2. The camera as claimed in claim 1, wherein when the rotating member rotates in a first direction, the first covering portion and the second covering portion move away from each other, and when the rotating member rotates in a second direction, the first covering portion and the second covering portion move toward each other.

3. The camera as claimed in claim 2, wherein the first covering portion comprises a first extending portion, and the second covering portion comprises a second extending portion, and when the first covering portion and the second covering portion move toward each other and abut each other, the first extending portion overlaps the second extending portion.

4. The camera as claimed in claim 1, wherein the rotating member comprises a first end portion and a second end portion opposite to the first end portion, and the first end portion connects with the first covering portion and the second end portion connects with the second covering portion.

5. The camera as claimed in claim 4, wherein the rotating member has a first opening and a second opening, and the first opening is formed on the first end portion and the second opening is formed on the second end portion, and the first covering portion comprises a first protrusion, engaging with the first opening, and the second covering portion comprises a second protrusion with the second opening, and when the rotating member rotates, the first protrusion and the second protrusion, respectively, move in the first opening and the second opening.

6. The camera as claimed in claim 1, wherein lens body comprises a first track, and the first covering portion engages with the first track, and when the rotating member rotates, the first covering portion moves in the first track.

7. The camera as claimed in claim 1, wherein the first covering portion comprises a second track, and the second covering portion engages with the second track, and when the rotating member rotates, the second covering portion moves in the second track.

8. The camera as claimed in claim 1, further comprising a button engaged with the first covering portion.

9. The camera as claimed in claim 8, wherein the first covering portion has a notch, and the button is engaged with the notch, and when the button moves in the notch, the rotating member is rotated accordingly.
